(19) United States
(12) Patent Application Publication
(10) Pub. No.: US 2026/0036688 A1
(43) Pub. Date: Feb. 5, 2026

(54) Carrier Frequency Dependent Reporting of Phase Measurements

(71) Applicant: Telefonaktiebolaget LM Ericsson (publ), Stockholm (SE)

(72) Inventors: Satyam Dwivedi, Täby (SE); Deep Shrestha, Linköping (SE); Gustav Lindmark, Linköping (SE); Siva Muruganathan, Stittsville (CA)

(21) Appl. No.: 19/101,426

(22) PCT Filed: Aug. 10, 2023
(86) PCT No.: PCT/EP2023/072246

§ 371 Date: Feb. 5, 2025

Related U.S. Application Data
(60) Provisional application No. 63/397,502, filed on Aug. 12, 2022.

(51) Int. Cl. G01S 11/10; G01S 5/02

(52) U.S. Cl. CPC G01S 11/10; G01S 5/0236

(57) ABSTRACT

The present disclosure provides a method in a network node for carrier phase measurements in a communication network. The method includes: obtaining a carrier phase measurement update rate for a UE moving through the network, based on a carrier frequency and a velocity of the UE; and sending the carrier phase measurement update rate to the UE in a carrier phase measurement update rate configuration.

### TECHNICAL FIELD

The embodiments described in the present disclosure relate generally to positioning, and more particularly to a framework for performing and reporting carrier phrase measurements used in positioning.

### BACKGROUND

Carrier phase measurements measure the range between a transmitter device and receiver device and be utilized, for example, to estimate the position of a device. Carrier phase measurements, therefore, are an objective of positioning standardization and will most likely become one of the most accurate ranging and positioning methods. However, the rate of carrier phase change depends on the Doppler frequency of the carrier signal. The Doppler frequency, in turn, depends on the velocity of the transmitting/receiving device (e.g., User Equipment (UE)). Such movement, though, can generate errors in the carrier phase measurements, which can hinder the accurate positioning of the device.

### SUMMARY

Embodiments of the present disclosure, therefore, provide apparatuses and corresponding methods for performing carrier phase measurements in a communication network and reporting those measurements to a network. More particularly, the present embodiments adapt the rate at which the carrier phase measurements are updated and/or reported based the velocity of a device moving through the network. Such a moving device may be, for example, User Equipment (UE).

Therefore, according to a first aspect, the present disclosure provides a method for performing carrier phase measurements in a communication network. The method is implemented by a User Equipment (UE) moving through the network and comprises the UE determining a carrier phase measurement update rate for the UE based on a carrier frequency and a current velocity of the UE. Once determined, the method comprises the UE performing carrier phase measurements according to the carrier phase measurement update rate.

According to a second aspect, the present disclosure provides a method for performing carrier phase measurements in a communication network. This aspect is also implemented by a UE moving through the network and comprises determining a carrier phase measurement update rate for the UE based on a carrier frequency and a current velocity of the UE and performing carrier phase measurements. Additionally, the method comprises reporting the carrier phase measurements to the network according to the carrier phase measurement update rate.

In a third aspect, the present disclosure provides method (160) for performing carrier phase measurements in a communication network. In this aspect, the method is implemented by a network node in a communication network and comprises determining a carrier phase measurement update rate for a UE moving through the network based on a carrier frequency and a current velocity of the UE. The method also comprises the network node sending the carrier phase measurement update rate to the UE in a carrier phase measurement update rate configuration.

In a fourth aspect, the present disclosure provides a method for performing carrier phase measurements in a communication network. The method in this aspect is implemented by a UE moving through the network and comprises the UE receiving, from the network, assistance data for performing carrier phase measurements and a plurality of carrier phase measurement update configurations. Each carrier phase measurement update configuration includes a corresponding carrier phase measurement update rate and maps to a different velocity of the UE. The method then comprises the UE selecting a carrier phase measurement update rate from the plurality of carrier phase measurement update configurations based on a carrier frequency and a current velocity of the UE and performing carrier phase measurements according to the selected carrier phase measurement update rate.

A fifth aspect of the present disclosure provides a method, implemented by a UE moving through the network, for performing carrier phase measurements in a communication network. In this aspect, the method comprises the UE receiving, from the network, assistance data for performing carrier phase measurements and a plurality of carrier phase measurement update configurations. Each carrier phase measurement update configuration includes a corresponding carrier phase measurement update rate and maps to a different velocity of the UE. So received, the method comprises the UE selecting a carrier phase measurement update rate from the plurality of carrier phase measurement update configurations based on a carrier frequency and a current velocity of the UE, performing the carrier phase measurements, and then reporting the carrier phase measurements to the network according to the selected carrier phase measurement update rate.

Additionally, in a sixth aspect, the present disclosure provides a User Equipment (UE) for performing carrier phase measurements in a communication network. In this aspect, the UE is configured to determine a carrier phase measurement update rate for the UE based on a carrier frequency and a current velocity of the UE and perform carrier phase measurements according to the carrier phase measurement update rate.

In a seventh aspect, the present disclosure provides a User Equipment (UE) for performing carrier phase measurements in a communication network. The UE comprises processing circuitry and memory circuitry. Executable instructions are stored in the memory circuitry that, when executed by the processing circuitry, causes the UE to determine a carrier phase measurement update rate for the UE based on a carrier frequency and a current velocity of the UE and perform carrier phase measurements according to the carrier phase measurement update rate.

In an eight aspect, the present disclosure provides a non-transitory computer readable medium comprising program code stored thereon that, when executed by processing circuitry of a User Equipment (UE) in a communications network, causes the UE to determine a carrier phase measurement update rate for the UE based on a carrier frequency and a current velocity of the UE and perform carrier phase measurements according to the carrier phase measurement update rate.

A ninth aspect of the present disclosure provides a User Equipment (UE) for performing carrier phase measurements in a communication network. In this aspect, the UE is configured to determine a carrier phase measurement update rate for the UE based on a carrier frequency and a current velocity of the UE, perform carrier phase measurements, and report the carrier phase measurements to the network according to the carrier phase measurement update rate.

In a tenth aspect, the present disclosure provides a User Equipment (UE) for performing carrier phase measurements in a communication network. The UE in this aspect comprises processing circuitry and memory circuitry. The memory circuitry comprises executable instructions stored thereon that, when executed by the processing circuitry, causes the UE to determine a carrier phase measurement update rate for the UE based on a carrier frequency and a current velocity of the UE, perform carrier phase measurements, and report the carrier phase measurements to the network according to the carrier phase measurement update rate.

In an eleventh aspect, the present disclosure provides a non-transitory computer readable medium comprising program code stored thereon that, when executed by processing circuitry of a User Equipment (UE) in a communications network, causes the UE to determine a carrier phase measurement update rate for the UE based on a carrier frequency and a current velocity of the UE, perform carrier phase measurements, and report the carrier phase measurements to the network according to the carrier phase measurement update rate.

In a twelfth aspect, the present disclosure provides a network node for performing carrier phase measurements in a communication network. In this aspect, the network node is configured to determine a carrier phase measurement update rate for a User Equipment (UE) moving through the network based on a carrier frequency and a current velocity of the UE and send the carrier phase measurement update rate to the UE in a carrier phase measurement update rate configuration.

In a thirteenth aspect, the present disclosure provides a network node for performing carrier phase measurements in a communication network. The network node comprises processing circuitry and memory circuitry. The memory circuitry comprises executable instructions stored thereon that, when executed by the processing circuitry, causes the network node to determine a carrier phase measurement update rate for a User Equipment (UE) moving through the network based on a carrier frequency and a current velocity of the UE and send the carrier phase measurement update rate to the UE in a carrier phase measurement update rate configuration.

In a fourteenth aspect of the present disclosure, a non-transitory computer readable medium is provided. The non-transitory computer readable medium comprises program code stored thereon that, when executed by processing circuitry of a network node in a communications network, causes the network node determine a carrier phase measurement update rate for a User Equipment (UE) moving through the network based on a carrier frequency and a current velocity of the UE and send the carrier phase measurement update rate to the UE in a carrier phase measurement update rate configuration.

In a fifteenth aspect, the present disclosure provides a User Equipment (UE) for performing carrier phase measurements in a communication network. In this aspect, the UE is configured to receive, from the network, assistance data for performing carrier phase measurements and a plurality of carrier phase measurement update configurations. Each carrier phase measurement update configuration includes a corresponding carrier phase measurement update rate and maps to a different velocity of the UE. The UE in this aspect is also configured to select a carrier phase measurement update rate from the plurality of carrier phase measurement update configurations based on a carrier frequency and a current velocity of the UE and perform carrier phase measurements according to the selected carrier phase measurement update rate.

In a sixteenth aspect, the present disclosure provides a User Equipment (UE) for performing carrier phase measurements in a communication network. The UE comprises processing circuitry and memory circuitry having executable instructions stored thereon that, when executed by the processing circuitry, causes the UE to receive, from the network assistance data for performing carrier phase measurements and a plurality of carrier phase measurement update configurations. Each carrier phase measurement update configuration includes a corresponding carrier phase measurement update rate and maps to a different velocity of the UE. The UE in this aspect is also configured to select a carrier phase measurement update rate from the plurality of carrier phase measurement update configurations based on a carrier frequency and a current velocity of the UE and perform carrier phase measurements according to the selected carrier phase measurement update rate.

A seventeenth aspect of the present disclosure provides a non-transitory computer readable medium comprising program code stored thereon that, when executed by processing circuitry of a User Equipment (UE) in a communications network, causes the UE to receive, from the network assistance data for performing carrier phase measurements and a plurality of carrier phase measurement update configurations. Each carrier phase measurement update configuration includes a corresponding carrier phase measurement update rate and maps to a different velocity of the UE. The UE in this aspect is also configured to select a carrier phase measurement update rate from the plurality of carrier phase measurement update configurations based on a carrier frequency and a current velocity of the UE and perform carrier phase measurements according to the selected carrier phase measurement update rate.

An eighteenth aspect of the present disclosure provides a User Equipment (UE) for performing carrier phase measurements in a communication network. The UE in this aspect is configured to receive, from the network, assistance data for performing carrier phase measurements and a plurality of carrier phase measurement update configurations, wherein each carrier phase measurement update configuration includes a corresponding carrier phase measurement update rate and maps to a different velocity of the UE. Additionally, the UE is configured to select a carrier phase measurement update rate from the plurality of carrier phase measurement update configurations based on a carrier frequency and a current velocity of the UE, perform the carrier phase measurements, and report the carrier phase measurements to the network according to the selected carrier phase measurement update rate.

In a nineteenth aspect, the present disclosure provides a User Equipment (UE) for performing carrier phase measurements in a communication network. The UE comprises processing circuitry and memory circuitry. Additionally, in this aspect, the memory circuitry comprises executable instructions stored thereon that, when executed by the processing circuitry, causes the UE to receive, from the network, assistance data for performing carrier phase measurements and a plurality of carrier phase measurement update configurations, wherein each carrier phase measurement update configuration includes a corresponding carrier phase measurement update rate and maps to a different velocity of the UE. Further, the executable instructions, when executed by the processing circuitry, causes the UE to select a carrier phase measurement update rate from the plurality of carrier phase measurement update configurations based on a carrier frequency and a current velocity of the UE, perform the carrier phase measurements, and report the carrier phase measurements to the network according to the selected carrier phase measurement update rate.

In a twentieth aspect, the present disclosure provides a non-transitory computer readable medium comprising program code stored thereon that, when executed by processing circuitry of a User Equipment (UE) in a communications network, causes the UE to receive, from the network, assistance data for performing carrier phase measurements and a plurality of carrier phase measurement update configurations, wherein each carrier phase measurement update configuration includes a corresponding carrier phase measurement update rate and maps to a different velocity of the UE. Additionally, the program code, when executed by the processing circuitry, causes the UE to select a carrier phase measurement update rate from the plurality of carrier phase measurement update configurations based on a carrier frequency and a current velocity of the UE, perform the carrier phase measurements, and report the carrier phase measurements to the network according to the selected carrier phase measurement update rate.

### BRIEF DESCRIPTION OF THE DRAWINGS

FIG. 1A is a functional block diagram illustrating an example 5G architecture for positioning according to one embodiment of the present disclosure.

FIG. 1B is a functional block diagram illustrating a node in the positioning architecture of FIG. 1A according to one embodiment of the present disclosure.

FIG. 2 is a graph illustrating the angle of arrival (an) of an incoming wave with respect to a direction of travel of a vehicle moving through a network with a velocity (v) according to one embodiment of the present disclosure.

FIG. 3 is a graph illustrating a number of carrier phase measurements that are needed for an increasing carrier frequency for a UE moving at an example speed of 150 kmh in order to remove a Doppler component according to one embodiment of the present disclosure.

FIG. 4 is a flow diagram illustrating a method, implemented by a UE, for configuring a carrier phase measurement rate according to one embodiment of the present disclosure.

FIG. 5 is a flow diagram illustrating a method, implemented by a network node, for configuring a carrier phase measurement rate according to one embodiment of the present disclosure.

FIG. 6 is a flow diagram illustrating a method, implemented at a UE, for configuring multiple carrier phase measurement update/reporting rates according to one embodiment of the present disclosure.

FIG. 7 is a flow diagram illustrating a method, implemented by a UE moving through a communication network, for performing carrier phase measurements in the communication network, according to one embodiment of the present disclosure.

FIG. 8 is a flow diagram illustrating a method, implemented by a UE moving through a communication network, for reporting carrier phase measurements in the communication network, according to one embodiment of the present disclosure.

FIG. 9 is a flow diagram illustrating a method, implemented by a network node in a communication network, for configuring a UE to perform carrier phase measurements for a UE moving through the communication network according to one embodiment of the present disclosure.

FIG. 10 is a flow diagram illustrating another method, implemented by a UE moving through a communication network, for performing carrier phase measurements in the communication network, according to one embodiment of the present disclosure.

FIG. 11 is a flow diagram illustrating a method, implemented by a UE moving through a communication network, for reporting carrier phase measurements in the communication network, according to one embodiment of the present disclosure.

FIG. 12 is a flow diagram illustrating a method for determining a carrier phase measurement update rate for a UE moving through a communications network according to one embodiment of the present disclosure.

FIG. 13 is a flow diagram illustrating a method for updating a carrier phase measurement update rate for a UE moving through a communications network according to one embodiment of the present disclosure.

FIG. 14 is a flow diagram illustrating a method, implemented by either a UE or a network node, according to one embodiment of the present disclosure.

FIG. 15 is a functional block diagram illustrating some components of a UE configured to determine a carrier phase measurement update rate for performing carrier phase measurements, and reporting those measurements, to a network according to one embodiment of the present disclosure.

FIG. 16 is a functional block diagram illustrating a computer program that, when executed by the processing circuitry of a UE, configures the UE to determine a carrier phase measurement update rate for performing carrier phase measurements, and reporting those measurements, to a network according to one embodiment of the present disclosure.

FIG. 17 is a functional block diagram illustrating some components of a network node configured to determine a carrier phase measurement update rate for a UE moving through the network according to one embodiment of the present disclosure.

FIG. 18 is a functional block diagram illustrating a computer program that, when executed by the processing circuitry of a network node, configures the network node to determine a carrier phase measurement update rate for a UE moving through the network according to one embodiment of the present disclosure.

FIG. QQ1 shows an example of a communication system in accordance with some embodiments of the present disclosure.

FIG. QQ2 shows a UE configured in accordance with some embodiments of the present disclosure.

FIG. QQ3 shows a network node configured in accordance with some embodiments of the present disclosure.

FIG. QQ4 is a block diagram of a host, which may be an embodiment of the host of FIG. QQ1, in accordance with various aspects described herein.

FIG. QQ5 is a block diagram illustrating a virtualization environment in which functions implemented by some embodiments may be virtualized.

FIG. QQ6 shows a communication diagram of a host communicating via a network node with a UE over a partially wireless connection in accordance with some embodiments.

### DETAILED DESCRIPTION

Embodiments of the present disclosure relate to configuring a device, such as a User Equipment (UE), for example, to perform carrier phase measurements in a communication network and to report those measurements to a network node in the network. More particularly, a UE configured according to the present embodiments considers its velocity as it moves through the network and adapts the rate at which the carrier phase measurements are updated and/or reported.

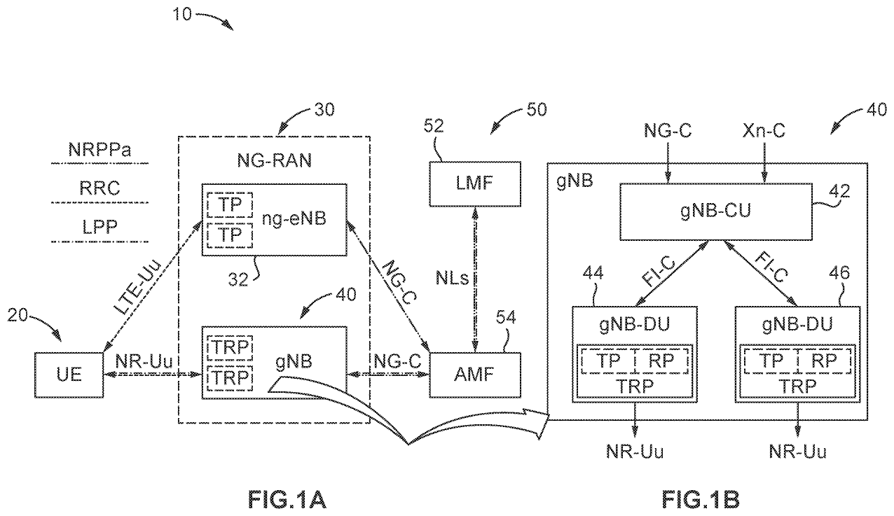

Turning now to the drawings, FIG. 1A is a functional block diagram illustrating some components of an example 5G positioning architecture 10 according to the present disclosure. In this embodiment, architecture 10 comprises a Next Generation Radio Access Network (NG-RAN) 30 and a Core Network (CN) 50. The NG-RAN 30 provides radio access service to 5G networks for a variety of devices, such as User Equipment (UE) 20, and includes one or more ng-eNBs 32 and one or more gNBs 40. Additionally, NG-RAN 30 supports the NG-eNB 32, which essentially supports LTE. The CN 50 comprises, inter alia, a Location Management Function (LMF) 52 and an Access and Mobility management Function (AMF) 54, both of which support positioning for UE 20. As seen in FIG. 1A, the entities in NG-RAN 30 and CN 50 communicate with each other using various protocols for signal transfer. Such protocols include, but are not limited to, NG-C interfaces between NG-RAN 30 and CN 50, and LTE-Uu and NR-Uu interfaces between NG-RAN 30 and UE 20.

In this embodiment, as seen in FIG. 1B, gNB 40 is partitioned into a gNB centralized unit (gNB-CU 42) and one or more gNB distributed units (gNB-DU 44 and gNB-DU 46). As is known in the art, gNB-CU 42 is configured to provide support for the higher layers of a protocol stack (e.g., SDAP, PDCP, and RRC), while gNB-DU 44 and gNB-DU 46 are configured to provide support for the lower layers of the protocol stack (e.g., RLC, MAC, and the Physical layer).

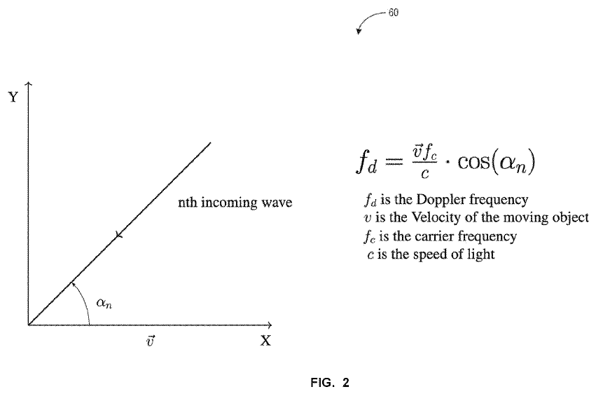

According to the present disclosure, determining the carrier phase measurement update/reporting rate depends on the carrier frequency and the velocity of a device (e.g., UE 20) as it moves through a network. FIG. 2 is a graph 60 illustrating the angle of arrival (αₙ) of an incoming wave with respect to a direction of travel of UE 20 moving through a network with a velocity (v) according to one embodiment of the present disclosure. More particularly, graph 60 shows the phenomena of Doppler frequency generation. As seen in graph 60, a mobile device, such as UE 20, moves through a network in the “X” direction. An electromagnetic n^{th} wave arrives at UE 20 while making an angle an with the direction of the movement of UE 20. The Doppler frequency shift in the carrier frequency is given by the equation:

$${f}_{d} = \frac{{vf}_{c}}{c} cos ( {α}_{n} )$$

where f_{d} is the Doppler frequency;
v is the velocity of the device (e.g., UE 20);
f_{c} is the carrier frequency;
c is the speed of light; and
αₙ is the angle of arrival of an incoming signal.

As previously stated, the rate of carrier phase change depends on the Doppler frequency of the carrier signal. The Doppler frequency, in turn, depends on the velocity of the transmitting/receiving device (e.g., UE 20). Such movement, though, can generate errors in the carrier phase measurements, which can hinder the accurate positioning of the device. However, how to deal with these errors when there is movement of the device with respect to the transmit/receive communication links is an open concern. Therefore, embodiments of the present disclosure adapt the updating and/or reporting rate of the carrier phase measurements based the velocity of the moving device, such as UE 20.

Accordingly, the present embodiments provide signaling to configure a UE 20 with carrier phase measurement updating/reporting rates (also referred to as carrier phase measurement updating/reporting periodicity) based on the carrier frequency and the velocity of UE 20. This configures a UE 20 to perform the carrier phase measurements and to report those measurements to the network according to the determined carrier phase measurement updating/reporting rates.

Further, the present embodiments provide signaling UE 20 to adapt carrier phase measurement updating/reporting rates (or carrier phase measurement updating/reporting periodicity) based on a velocity change for UE 20. In some embodiments, signaling is provided to signal a plurality of carrier phase measurement updating/reporting rates (or a plurality of carrier phase measurement updating/reporting periodicities) to the UE 20. The plurality of carrier phase measurement updating/reporting rates correspond to different velocities for UE 20, or UE velocity ranges for UE 20. The UE 20 is then able to select one the plurality of carrier phase measurement updating/reporting rates according to the velocity or the velocity range of the UE.

Embodiments of the present disclosure provide benefits and advantages that conventional systems and devices are not able to provide. For example, the present embodiments enable accurate carrier phase measurements by removing the effect of Doppler frequency of a UE 20 moving through the network. This, in turn, yields a more accurate estimation for the position of a UE 20. Moreover, with the present embodiments, the effect of Doppler frequency on all channel parameters can be accurately removed. Additionally, the appropriate sampling of Doppler component allows for the tracking of the Doppler parameter.

The following channel model can be used to illustrate the effect of Doppler frequency.

$${H}_{n , k} = {\sum }_{l - 1}^{L} {α}_{l} {a}_{r x} ( {θ}_{r} ) {a}_{tx}^{T} ( {ϕ}_{l} ) {e}^{- j 2 π Δ {f}^{τ l}} {e}^{- j 2 π {kT}_{s} Δ {f}_{d , l}}$$

where αᵣₓ(θᵣ) and aₜₓ^{T}(θₗ) are the receive and transmit responses as a function of the angle of arrival (AoA) (θᵣ) and the angle of departure (AoD) (ϕₗ), respectively.
The effect of Doppler frequency on channel parameters can be seen from this equation. Particularly, the presence of the Doppler frequency term affects all other channel parameter terms. Therefore, the present embodiments estimate the Doppler frequency and remove it from consideration to more accurately estimate the other channel parameters. To remove effect of Doppler frequency error, the present embodiments sample the measurements at an appropriate rate so that Doppler frequency is sampled at least at the Nyquist rate. Once appropriately sampled, the Doppler frequency can be removed from the measurements. It should be noted that the above expression can also be written as:

$${H}_{n , k} = {\sum }_{l = 1}^{L} {α}_{l} {a}_{r x} ( {θ}_{r} ) {a}_{tx}^{T} ( {ϕ}_{l} ) {e}^{- j 2 π ( n Δ {f}^{τ l} + {kT}_{s} {v}_{l} )}$$

where the term 2π(nΔ_{f}τₗ+kTₛvₗ) is the phase of the channel affected by the Doppler component. Appropriately sampling and removing the Doppler frequency according to the present embodiments facilitates the accurate estimation of the signal phase.

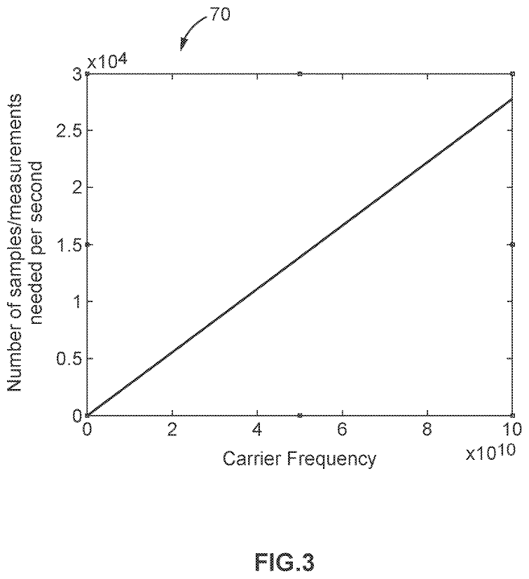

According to the present disclosure, the carrier phase measurement reporting rate may be determined by assuming a very high, maximum speed of the UE (e.g., 150 kph) and the corresponding Doppler frequency that such a speed introduces. The rate of measurement will then be at least the Nyquist rate of the calculated Doppler frequency. FIG. 3 is a graph 70 illustrating a number of carrier phase measurements that are needed for an increasing carrier frequency for a UE moving at an example maximum speed of 150 kmh in order to remove a Doppler component according to one embodiment of the present disclosure.

It should be noted here that the present disclosure utilizes the term “carrier phase measurement update rate.” In the context of the present embodiments, the term “carrier phase measurement update rate” (also referred to as “carrier phase measurement update periodicity”) means that a device, such as UE 20, updates (i.e., performs) the carrier phase measurements with a specified periodicity. This is suitable for a UE 20 that is capable of UE-based positioning. In such cases, UE 20 does not report the carrier phase measurements to the network, and thus, updates the carrier phase measurements according to the carrier phase measurement update rate.

However, in the context of the present embodiments, the term “carrier phase measurement update rate” can also mean how often (i.e., with what periodicity) UE 20 reports the carrier phase measurements to the network. In these situations, the “carrier phase measurement update rate” means that the UE reports the carrier phase measurement to a network node network (e.g., to an LMF) with a certain specified periodicity. This is suitable for UE-assisted positioning scenarios in which UE 20 reports the carrier phase measurements to the network.

### Configuring a Carrier Phase Measurement Update Rate at a UE

In one embodiment, the present disclosure determines a carrier phase measurement update rate to send to a UE 20. Regardless of whether the UE does the measurement for UE-assisted positioning or UE-based positioning, sending the carrier phase measurement update rate to UE 20 configures the UE with the determined carrier phase measurement update rate.

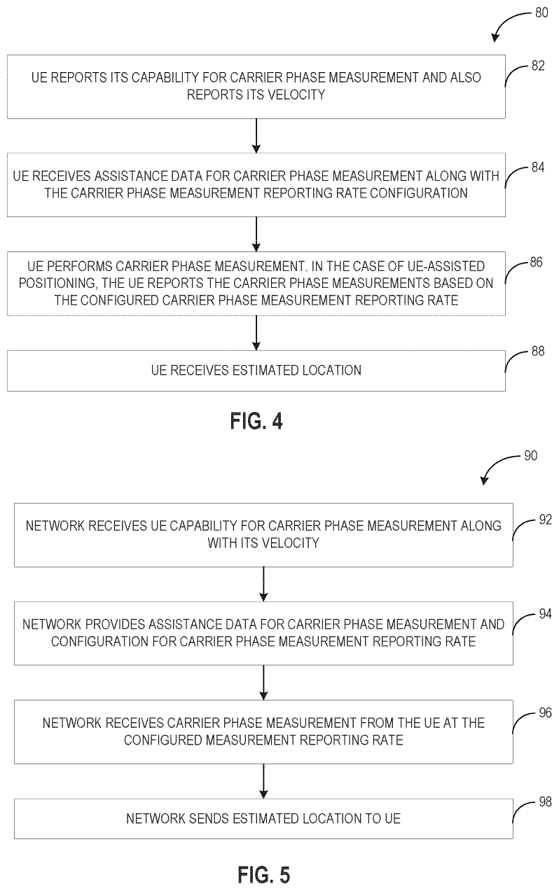

FIG. 4 is a flow diagram illustrating a method 80, implemented by UE 20, for configuring a carrier phase measurement update rate according to one embodiment of the present disclosure. As seen in FIG. 4, UE 20 reports its capability for carrier phase measurement and requests assistance data. The UE also reports its velocity (box 82), which may, for example, be determined based on an IMU sensor, for example. In an optional procedure, UE 20 may not send its capability for carrier phase measurement to the network. Rather, in some cases, UE 20 reports only its velocity to the network. Reporting in this manner can, in one embodiment, functionally trigger a request for the network to obtain and send assistance data for carrier phase measurements to UE 20.

Next, UE 20 receives the assistance data for carrier phase measurements along with a carrier phase measurement update rate configuration (box 84), performs the carrier phase measurement at the configured carrier phase measurement update rate, and reports the measurement to the network at the configured carrier phase measurement update rate (box 86). Then, UE 20 receives an estimated location for UE 20 from the network (box 88). It should be noted, however, that in cases where UE 20 is capable of UE-based carrier phase positioning, UE 20 may not report the carrier phase measurements to the network and/or receive the estimated location.

### Configuring a Carrier Phase Measurement Update Rate at a Network Node

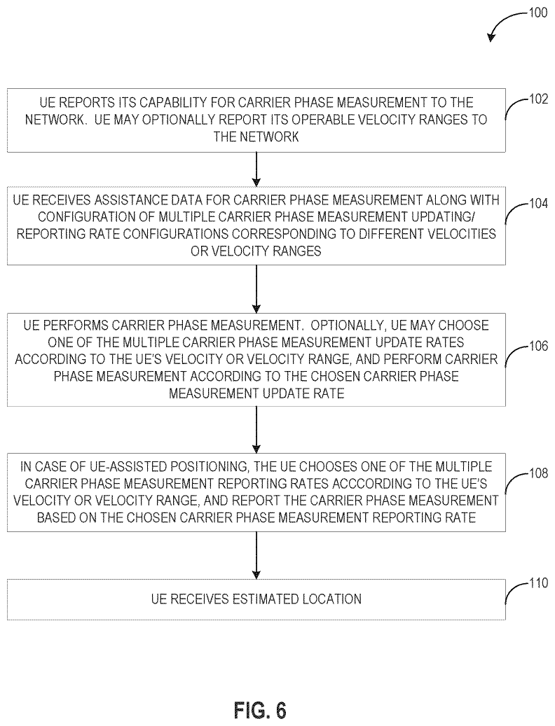

FIG. 5 is a flow diagram illustrating a method 90, implemented by a network node, for configuring a UE with a carrier phase measurement rate according to one embodiment of the present disclosure. The network node may be, for example, the LMF 52 and/or gNB 40.

As seen in FIG. 5, method 90 begins with the network receiving, from UE 20, the UE's capability for carrier phase measurement along with the velocity of the UE 20 (box 92). In some cases, however, the network may not receive the UE's capability for carrier phase measurement. For example, the network may not receive the UE's capability for the carrier phase measurement in situations where the network already has the UE positioning capability context from earlier positioning procedures for the same UE. In these cases, however, the network still receives the reported UE's velocity. In the present embodiments, this triggers the network to send the carrier phase measurement assistance data to UE 20 along with the carrier phase measurement report update rate based on the UE reported velocity measurement.

Next, the network provides the assistance data and carrier phase measurement report rate configuration to the UE (box 94). The network then receives a carrier phase measurement report from UE 20 at the configured measurement reporting rate (box 96). If UE 20 is capable of UE-based carrier phase positioning, however, UE 20 may not report the estimated UE location to the network. Regardless, the network then sends an estimated location to UE 20 (box 98). If the location information is triggered by a third-party request, however, the network may report the estimated location of the UE 20 to a third-party location information consumer.

### Configuring Multiple Carrier Phase Measurement Update/Reporting Rates

In another embodiment, the present disclosure provides multiple carrier phase measurement updating/reporting rates to the UE. Each carrier phase measurement updating/reporting rate corresponds to a different UE velocity or UE velocity range. The UE then chooses one of the multiple carrier phase measurement updating/reporting rates according to the UE's velocity or the UE's velocity range. In some optional embodiments, the UE may also report its velocity or velocity range along with the carrier phase measurement when such measurement is reported to the network. Regardless of whether the UE performs the measurements for UE-assisted positioning or UE-based positioning, though, the following method is implemented.

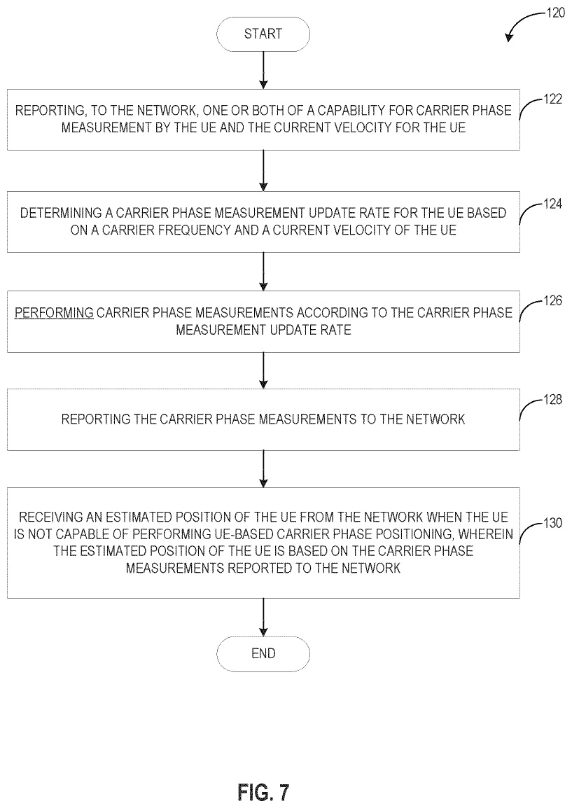

Particularly, FIG. 6 is a flow diagram illustrating a method 100, implemented at a UE 20, for configuring multiple carrier phase measurement update/reporting rates according to one embodiment of the present disclosure. As seen in FIG. 6, UE 20 reports its capability for carrier phase measurement and requests for the assistance data. Optionally, UE 20 may report the velocities or velocity ranges at which it is capable of operating (box 102). For instance, UE 20 may report that it is capable of operating in the velocity ranges 10-20 kph, 20-30 kph, etc., as part of its UE capability signaling.

Next, UE 20 receives assistance data from the network for the carrier phase measurements along with multiple carrier phase measurement updating/reporting rate configurations corresponding to different velocities or velocity ranges (box 104). For instance, when a UE is capable of travelling in two UE velocity ranges e.g., 10-20 kmh and 20-30 kmh, two different carrier phase measurement updating/reporting rates may be configured to the UE where each rate corresponds to a respective one of the two velocity ranges. Alternatively, the two different carrier phase measurement updating/reporting rates may respectively correspond to two different velocities (e.g., 10 kmh and 20 kmh). The carrier phase measurement updating/reporting rate determines the rate or periodicity at which UE 20 reports the carrier phase measurement(s) to the network.

In some other embodiments, UE 20 receives multiple carrier phase measurement update rate configurations where each of the multiple carrier phase measurement update rate configuration corresponds to a different velocity or velocity range. For instance, when a UE is capable of travelling in two UE velocity ranges e.g., 10-20 kph and 20-30 kmh, two different carrier phase measurement updating/reporting rates may be configured to the UE where each rate corresponds to a respective one of the two velocity ranges. Alternatively, the two different carrier phase measurement updating/reporting rates may respectively correspond to two different velocities (e.g., 10 kmh and 20 kmh). Regardless, the carrier phase measurement updating/reporting rate determines the rate or periodicity at which UE 20 performs the carrier phase measurement(s).

In some embodiments, the UE may receive one or both of (1) multiple carrier phase measurement update rate configurations and (2) multiple carrier phase measurement report rate configurations.

Next, UE 20 performs the carrier phase measurements. Optionally, if the UE 20 is configured with multiple carrier phase measurement update rates, UE may choose one of the multiple carrier phase measurement update rates according to the UE's velocity or velocity range and perform carrier phase measurements according to the chosen carrier phase measurement update rate (box 106).

Next, in cases of UE-assisted positioning, the UE 20 chooses one of the multiple carrier phase measurement reporting rates according to the UE's velocity or velocity range and reports the carrier phase measurements based on the chosen carrier phase measurement reporting rate (box 108). In some optional cases, such as when it is capable of UE-based carrier phase positioning, UE 20 may not report the carrier phase measurement to the network.

Regardless, UE 20 receives an estimated location from the network (box 110). UE may not receive the estimated location in all cases, however. For example, UE 20 may not receive an estimated location from the network in cases where the UE is capable of UE-based carrier phase positioning.

### Other Embodiments

In one of the embodiments, the network already has an estimation of the UE's velocity and the UE's capability for performing carrier phase measurements. In this case, UE 20 may not send its capability for carrier phase measurement and its velocity to the network. Rather, the network may initiate the carrier phase measurement by considering the UE capability context it has from a previous positioning procedure and may configure UE with the carrier phase measurement reporting rate based on an estimated UE velocity. To determine the UE velocity, the network may exploit, for example, the handover rate of the UE. Alternatively, or additionally, network may estimate the UE's velocity based on Doppler information from more than one cells to which the UE is connected. There are, of course, other methods to acquire UE velocity. Thus, the present embodiments are not limited to the methods explicitly stated herein.

In an embodiment, a scheduling restriction and/or the scheduling of other downlink (DL) signals/channels is based on the carrier phase measurement reporting rate with which a UE 20 is configured.

In an embodiment, if the UE is not in RRC_CONNECTED mode, the carrier phase measurement report rate may be updated to the discontinued reception cycle that the UE is configured with, or vice-versa.

In an embodiment, the carrier phase measurement report rate may also change depending on a change in UE velocity. Further, energy saving aspects of the present disclosure are not precluded, if UE 20 reports carrier phase measurements by grouping, then various groupings may be applied. For example, measurement reports may contain more than one measurement instances. Each measurement instance is tagged with a corresponding update rate and contains multiple measurements with the same measurement report rate.

### Dynamic Adaptation of the Transmission Rate of Reference Signals for Carrier Phase Measurements

In one embodiment, the function responsible for position calculation (e.g., LMF 52 for network-based positioning or UE 20 for UE based positioning) implements a failure detection algorithm which is configured to recognize that the carrier phase measurement update rate is either too low or unnecessarily high. Such an algorithm may or may not be able to estimate the UE velocity explicitly. However, in any case, the output of can be used to dynamically adapt the measurement update rate over time.

In one embodiment, for UE based positioning, UE 20 requests that downlink reference signals for carrier phase measurement should be sent at a specific rate. This can be done by the UE initiating a DL Positioning Reference Signal (PRS) reconfiguration request to LMF 52.

In one embodiment, for UE based positioning, the UE requests that it should be allocated slots for uplink reference signals at a specific rate.

Additionally, in one embodiment, for network-based and UE-assisted positioning, the network can request that the UE transmit UL reference signals for carrier phase measurements at a specific rate.

In one embodiment, for network-based and UE-assisted positioning, the network adapts the rate of downlink reference signals for carrier phase measurements and requests the UE to measure and report the carrier phase for them. This can be accomplished, for example, by the LMF 52 initiating a DL PRS reconfiguration request.

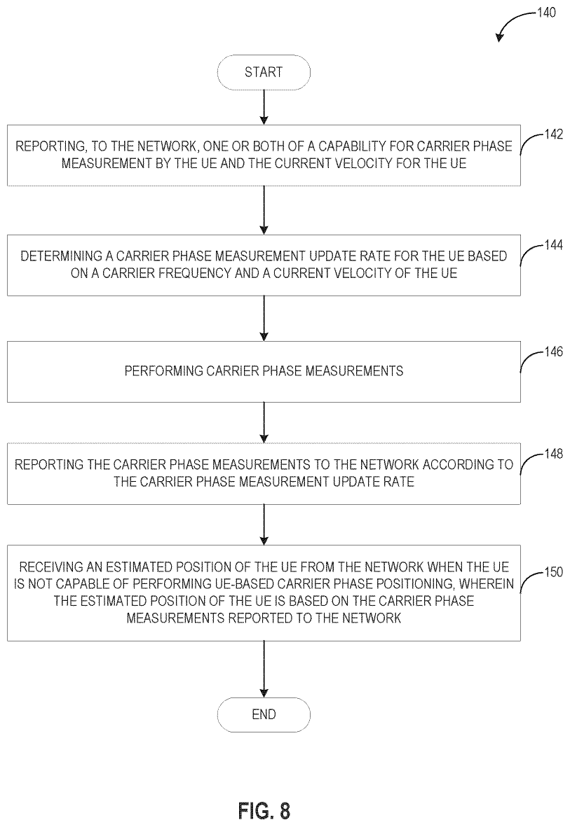

FIG. 7 is a flow diagram illustrating a method 12, implemented by UE 20 moving through a communication network, for performing carrier phase measurements in the communication network, according to one embodiment of the present disclosure. As seen in FIG. 7, UE 20 reports, to the network, one or both of a capability for carrier phase measurement by UE 20 and the current velocity for UE 20 (box 122). For example, in one embodiment, the current velocity of UE 20 is based on a measurement by an Inertial Measurement Unit (IMU) sensor at UE 20. UE 20 then determines a carrier phase measurement update rate for UE 20 based on a carrier frequency and the current velocity of the UE (box 124). UE 20 then performs carrier phase measurements according to the carrier phase measurement update rate (box 126) and reports the carrier phase measurements to the network (box 128). UE 20 may then receive an estimated position of the UE 20 from the network in cases where UE 20 is not capable of performing UE-based carrier phase positioning (box 130). The estimated position received by UE 20 is based on the carrier phase measurements reported to the network.

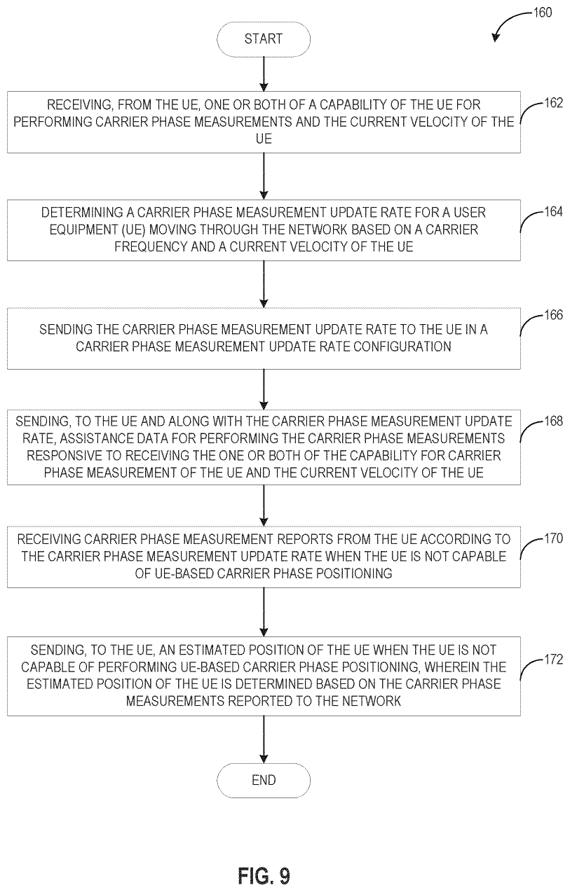

FIG. 8 is a flow diagram illustrating a method 140, implemented by a UE 20 moving through a communication network, for reporting carrier phase measurements in the communication network, according to one embodiment of the present disclosure. In this embodiment, UE 20 reports, to the network, one or both of a capability for carrier phase measurement by UE 20 and the current velocity for UE 20, as previously described (box 142). As above, in one embodiment of the present disclosure, the current velocity reported by UE 20 is based on a measurement taken by an IMU sensor at UE 20. UE 20 then determines a carrier phase measurement update rate for UE 20 based on a carrier frequency and the current velocity of the UE, as previously described (box 144). So determined, UE 20 performs the carrier phase measurements (box 146), and then reports those measurements to the network according to the determined carrier phase measurement update rate (box 148). In cases where UE 20 is not capable of performing UE-based carrier phase positioning, UE 20 may receive an estimated position of the UE 20 from the network (box 150). The estimated position received by UE 20 is based on the carrier phase measurements reported to the network.

In one embodiment, reporting the current velocity for UE 20 triggers a request for the assistance data from the network for performing the carrier phase measurements. Thus, in at least one embodiment, UE 20 receives the assistance data from the network in response to reporting its current velocity.

In one embodiment, the carrier phase measurement update rate for UE 20 is received from the network in a carrier phase measurement update rate configuration.

In embodiments where UE 10 is capable of performing UE-based carrier phase positioning, UE 20 may refrain from performing and/or reporting the carrier phase measurements to the network. However, in cases where UE 20 is not capable of performing UE-based carrier phase positioning, UE 20 reports the carrier phase measurements to the network.

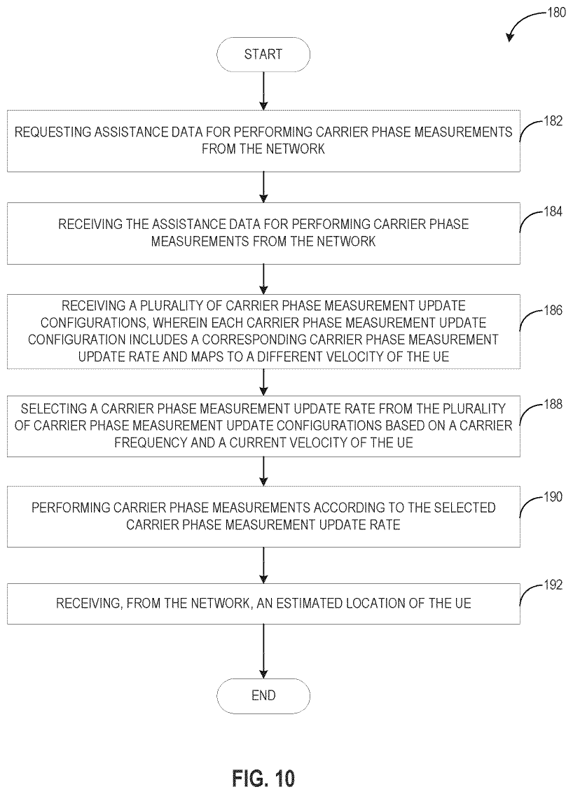

FIG. 9 is a flow diagram illustrating a method 160, implemented by a network node in a communication network, for configuring a UE to perform carrier phase measurements for a UE moving through the communication network according to one embodiment of the present disclosure. The network node may be, for example, LMF 52 or gNB 40.

Method 160 begins with the network node receiving, from the UE, one or both of a capability of UE 20 for performing carrier phase measurements and the current velocity of UE 20 (box 162) as it moves through the network. The network node then determines a carrier phase measurement update rate for the UE 20 based on a carrier frequency and a current velocity of the UE (box 164). So determined, the network node sends the determined carrier phase measurement update rate to UE 20 in a carrier phase measurement update rate configuration (box 166). Additionally, along with the carrier phase measurement update rate, network node also sends assistance data for performing the carrier phase measurements (box 168). In one embodiment, the assistance data sent to UE 20 responsive to receiving the UE's capability for carrier phase measurement and the current velocity. Next, the network node receives the carrier phase measurement reports from UE 20 according to the carrier phase measurement update rate (box 170). In these cases, UE 20 is not capable of UE-based carrier phase positioning. Additionally, when the UE is not capable of performing UE-based carrier phase positioning, the network nodes sends an estimated position of the UE (box 172). The estimated position of UE 20 is determined based on the carrier phase measurements reported to the network.

In one or more embodiments, the estimated position of UE 20 is sent to a third party device responsive to the network node receiving a location request for UE 20 from the third party.

In one embodiment, the network comprises context information that indicates an estimated capability of UE 20 for performing carrier phase measurements and an estimated velocity for the UE 20. In these cases, the network is configured to control UE 20 to initiate performing the carrier phase measurements based on the context information. Accordingly, the carrier phase measurement update rate may be sent to UE 20 based on the estimated velocity.

In another embodiment, the estimated velocity for UE 20 is determined based on a handover rate for UE 20. Alternatively, or additionally, the estimated velocity for UE 20 is determined based on Doppler information obtained from one or more cells connected to UE 20.

In at least one embodiment, the estimated capability of UE 20 for performing carrier phase measurements and the estimated velocity for the UE 20 are based on information associated with one or more previous UE positioning procedures.

In another embodiment, a scheduling restriction is determined based on the carrier phase measurement update rate configuration sent to the UE.

Additionally, in at least one embodiment, the scheduling of one or more downlink channels is determined based on the carrier phase measurement update rate configuration sent to the UE.

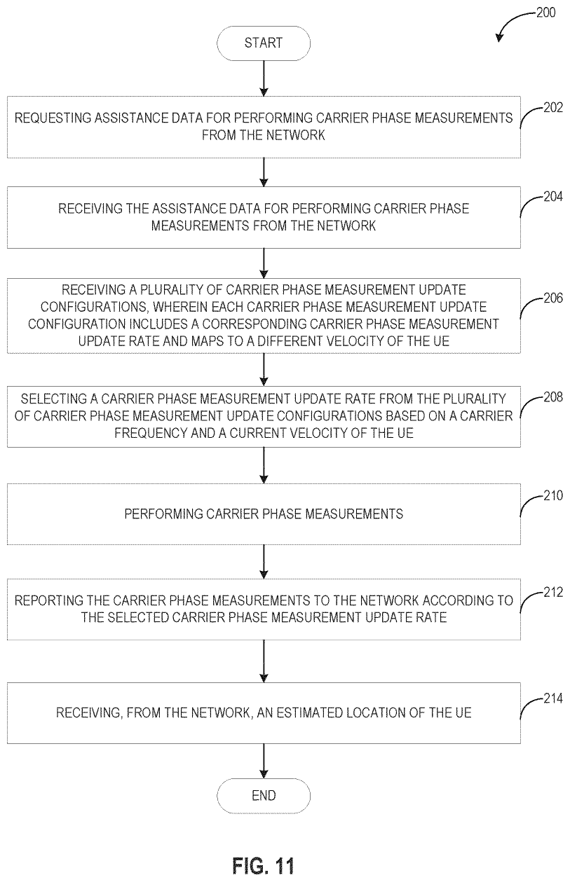

FIG. 10 is a flow diagram illustrating another method 180, implemented by a UE 20 moving through a communication network, for performing carrier phase measurements in the communication network, according to one embodiment of the present disclosure. As seen in FIG. 10, method 180 begins with UE 20 requesting assistance data for performing carrier phase measurements (box 182). In response to the request, UE 20 receives, from the network, the assistance data for performing carrier phase measurements and a plurality of carrier phase measurement update configurations (box 184, 186). In this embodiment, each carrier phase measurement update configuration includes a corresponding carrier phase measurement update rate and maps to a different velocity of the UE. Upon receipt, UE 20 selects a carrier phase measurement update rate from the plurality of carrier phase measurement update configurations based on a carrier frequency and a current velocity of the UE (box 188) and performs the carrier phase measurements according to the selected carrier phase measurement update rate (box 190). UE 20 then receives an estimated location for UE 20 from the network (box 192).

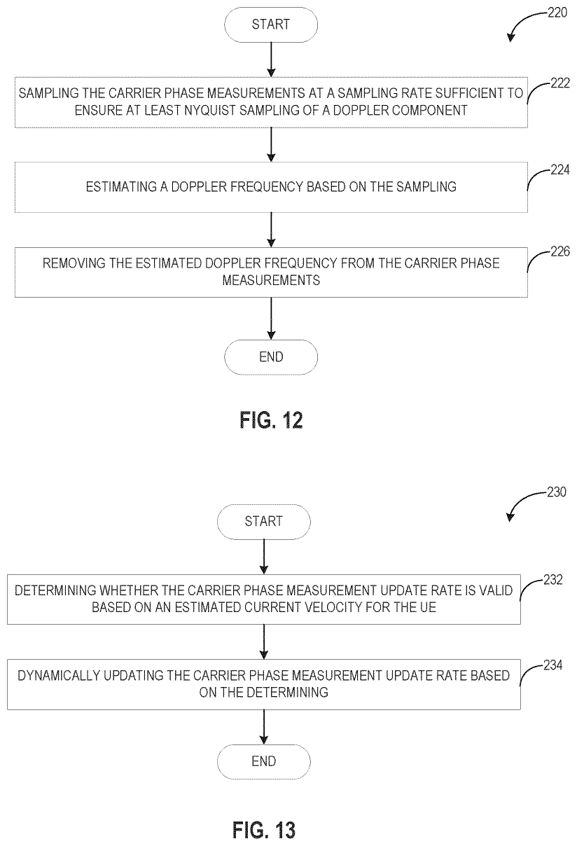

FIG. 11 is a flow diagram illustrating a method 200, implemented by a UE 20 moving through a communication network, for reporting carrier phase measurements in the communication network, according to one embodiment of the present disclosure. As seen in FIG. 11, UE 20 requests assistance data for performing carrier phase measurements from the network (box 202) and receives, in response, the assistance data (box 204). In addition, UE 20 also receives a plurality of carrier phase measurement update configurations (box 206). In this embodiment, each carrier phase measurement update configuration includes a corresponding carrier phase measurement update rate and maps to a different velocity of the UE. UE 20 then selects a carrier phase measurement update rate from the plurality of carrier phase measurement update configurations based on a carrier frequency and a current velocity of the UE (box 208) and performs the carrier phase measurements (box 210). UE 20 then reports the carrier phase measurements to the network according to the selected carrier phase measurement update rate (box 212) and receives, thereafter, an estimated location for UE 20 from the network (box 214).

In one embodiment, the selected carrier phase measurement rate specifies a rate or periodicity with which the UE performs the carrier phase measurements. In another embodiment, the selected carrier phase measurement rate specifies a rate or periodicity with which the UE reports the carrier phase measurements to the network.

In one embodiment, UE 20 refrains from reporting its capability for performing carrier phase measurements to the network. These situations may occur, for example, when the network already has an estimation of the capability of UE 20 for performing carrier phase measurements.

In one embodiment, UE 20 refrains from reporting, to the network, one or more velocities at which UE 20 is capable of operating when the network comprises an estimation of the one or more velocities at which the UE is capable of operating.

In one embodiment, when the network comprises an estimation of the one or more velocity ranges at which UE 20 is capable of operating, UE 20 refrains from reporting the one or more velocity ranges.

In one embodiment, each carrier phase measurement update configuration includes a corresponding carrier phase measurement update rate and maps to a different velocity range of the UE.

In one embodiment, UE 20 selects the carrier phase measurement update rate from the plurality of carrier phase measurement update configurations based on the carrier frequency and a velocity range of the UE.

In one embodiment, when UE 20 is capable of UE-assisted positioning, UE 20 selects the carrier phase measurement update rate and reports the carrier phase measurements to the network according to the selected carrier phase measurement update rate.

In one embodiment, the carrier phase measurement update rate is updated to a discontinued reception cycle configured at UE 20 when the UE 20 is not in a RRC_CONNECTED mode.

In one embodiment, the carrier phase measurement update rate varies based on changes in the velocity of the UE.

In one embodiment, a carrier phase measurement report sent to the network comprises one or more measurement instances with each measurement instance being tagged with the carrier phase measurement update rate. In these cases, each measurement instance may comprise a plurality of measurements having a same carrier phase measurement update rate.

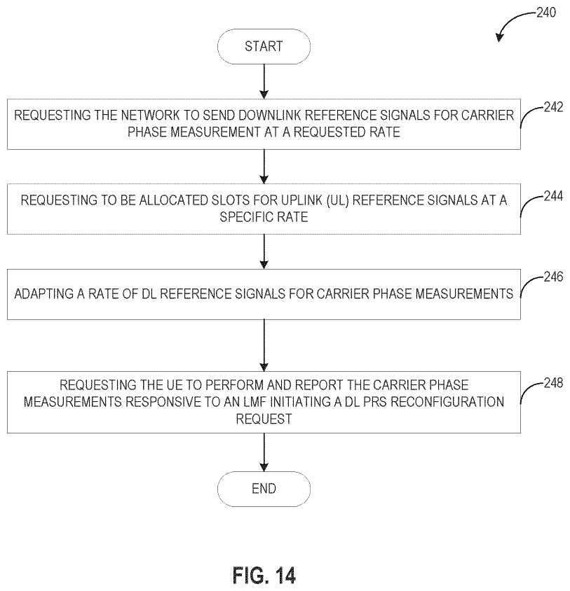

FIG. 12 is a flow diagram illustrating a method 220 for determining a carrier phase measurement update rate for a UE 20 moving through a communications network according to one embodiment of the present disclosure. Determining the carrier phase measurement update rate may be performed, for example, by UE 20, gNB 40, or LMF 52.

Regardless of which entity performs determines the carrier phase measurement update rate, the entity first samples carrier phase measurements at a sampling rate sufficient to ensure at least Nyquist sampling of a Doppler component (box 222). Based on the sampling, the entity estimates a Doppler frequency (box 224) and removes the estimated Doppler frequency from the carrier phase measurements (box 226).

According to the present disclosure, the Doppler frequency is estimated based on an estimated maximum velocity for the UE. Additionally, in at least one embodiment, the carrier phase measurement update rate for UE 20 is determined based on previous carrier phase measurements after they have been processed to remove the Doppler frequency.

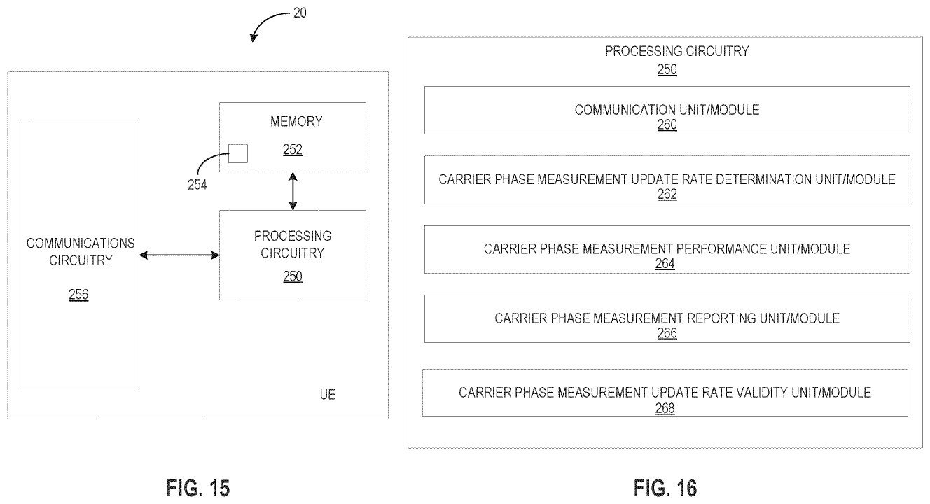

FIG. 13 is a flow diagram illustrating a method 230 for updating a carrier phase measurement update rate for a UE 20 moving through a communications network according to one embodiment of the present disclosure. Method 230 may be implemented by the network node (e.g., gNB 40, LMF 52) or by UE 20.

As seen in FIG. 13, method 230 calls for determining whether the carrier phase measurement update rate is valid for UE 20 based on an estimated current velocity for the UE (box 232). If the carrier phase measurement update rate is determined to be valid, method 230 calls for dynamically updating the carrier phase measurement update rate (box 234).

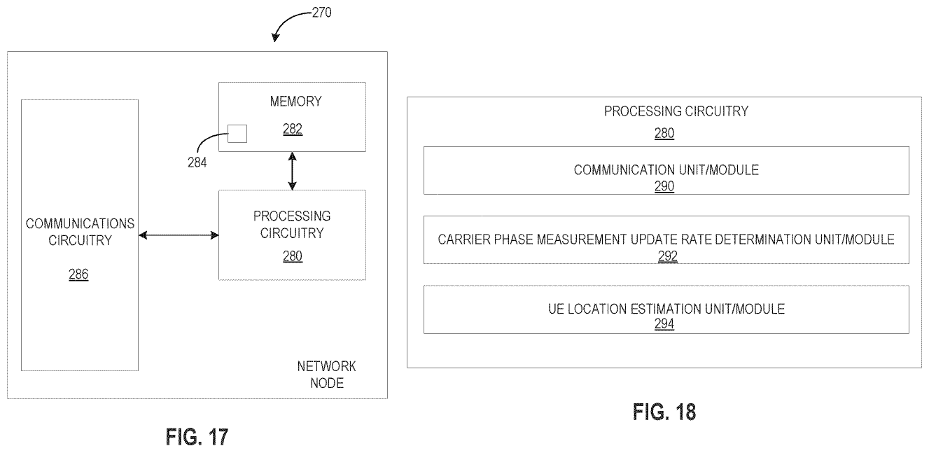

FIG. 14 is a flow diagram illustrating a method 240, implemented by UE 20 and/or a network node, such as gNB 40 or LMF 52, according to one embodiment of the present disclosure. As seen in FIG. 14, UE 20 requests the network to send downlink reference signals for carrier phase measurement at a requested rate (box 242). In one embodiment, by requesting the network to send the downlink reference signals, the UE 20 initiates a Downlink (DL) Positioning Reference Signal (PRS) reconfiguration request to the LMF 52. As seen in FIG. 14, UE 20 may also request to be allocated slots for uplink (UL) reference signals at a specific rate (box 244).

In addition, UE 20 may also receive a request from the network to transmit UL reference signals for carrier phase measurements at a specific rate. In response to the request, UE 20 adapts a rate of DL reference signals for carrier phase measurements (box 246). Further, in response to LMF 52 initiating a DL PRS reconfiguration request, the network requests UE 20 to perform and report the carrier phase measurements (box 248).

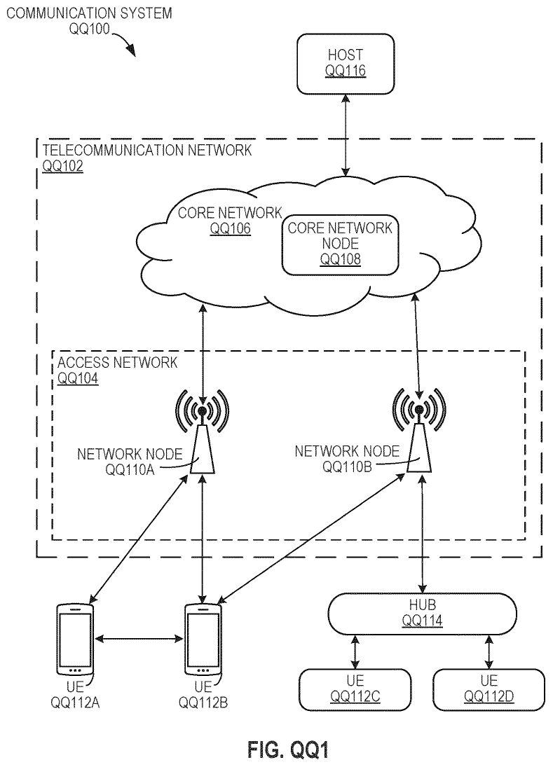

FIG. 15 is a functional block diagram illustrating some components of a UE 20 configured to determine a carrier phase measurement update rate for performing carrier phase measurements, and reporting those measurements, to a network according to one embodiment of the present disclosure. As seen in FIG. 15, UE 20 comprises processing circuitry 250, memory circuitry 252, and communications circuitry 256. Additionally, as described in more detail below, memory circuitry 252 stores a computer program 254 that, when executed by processing circuitry 250, configures UE 20 to implement the methods herein described.

In more detail, processing circuitry 250 controls the overall operation of UE 20 and processes the data and information according to the present embodiments. Such processing includes, but is not limited to, determining a carrier phase measurement update rate for the UE based on a carrier frequency and a current velocity of the UE, performing carrier phase measurements according to the carrier phase measurement update rate, and/or reporting the carrier phase measurements to the network according to the carrier phase measurement update rate. Additionally, in some embodiments, the processing further includes UE 20 receiving assistance data for performing carrier phase measurements as well as a plurality of carrier phase measurement update configurations. Each carrier phase measurement update configuration maps to a different velocity of UE 20 and includes a corresponding carrier phase measurement update rate. Further, such processing includes selecting a carrier phase measurement update rate from the plurality of carrier phase measurement update configurations based on a carrier frequency and a current velocity of UE 20. In this regard, processing circuitry 250 may comprise one or more microprocessors, hardware, firmware, or a combination thereof.

Memory circuitry 252 comprises both volatile and non-volatile memory for storing computer program code and data needed by the processing circuitry 250 for operation. Memory circuitry 252 may comprise any tangible, non-transitory computer-readable storage medium for storing data including electronic, magnetic, optical, electromagnetic, or semiconductor data storage. As stated above, memory circuitry 252 stores a computer program 254 comprising executable instructions that configure the processing circuitry 250 to implement the methods herein described. A computer program 254 in this regard may comprise one or more code modules corresponding to the functions described above.

In general, computer program instructions, such as computer program 254, and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 254 for configuring the processing circuitry 250 as herein described may be stored in a removable memory, such as a portable compact disc, portable digital video disc, or other removable media. The computer program 254 may also be embodied in a carrier such as an electronic signal, optical signal, radio signal, or computer readable storage medium.

The communications circuitry 256 communicatively connects UE 20 to NG-RAM 30, as is known in the art. In some embodiments, for example, communications interface circuitry 256 wirelessly communicatively connects UE 20 to NG-RAM 30 over an air interface. In other embodiments, UE 20 communicatively connects UE 20 to NG-RAN 30 via a wireline interface. As such, communications circuitry 256 may comprise, for example, an ETHERNET card or other circuitry configured to communicate wirelessly with one or more other nodes via the communications network.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, such as processing circuitry 250. Such processing circuitry may include one or more microprocessor or microcontrollers, as well as other digital hardware, which may include digital signal processors (DSPs), special-purpose digital logic, and the like. The processing circuitry may be configured to execute program code (e.g., computer program 254) stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

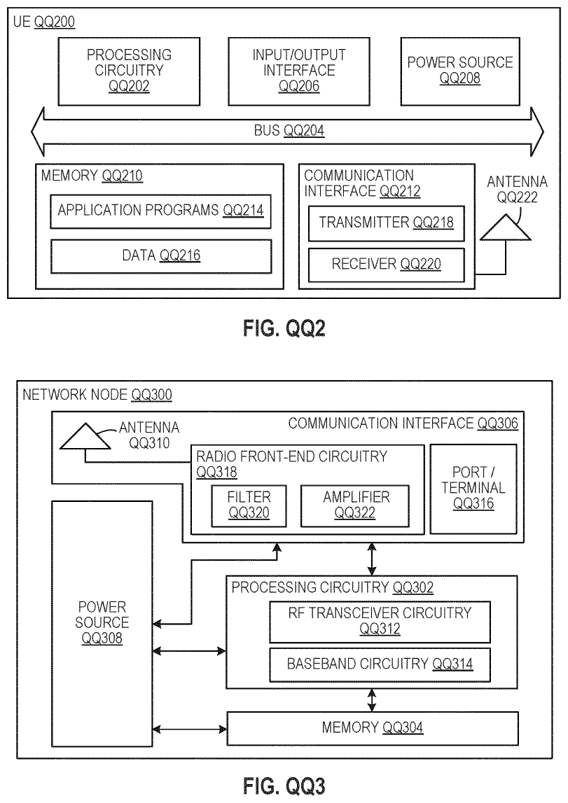

FIG. 16 is a functional block diagram illustrating a computer program (e.g., computer program 254) that, when executed by the processing circuitry 250 of UE 20, causes UE 20 to perform the methods herein described. Particularly, as seen in FIG. 16, computer program 254 executed by processing circuitry 250 comprises a communication unit/module 260, a carrier phase measurement update rate determination unit/module 262, a carrier phase measurement performance unit/module 264, a carrier phase measurement reporting unit/module 266, and a carrier phase measurement update rate validity unit/module 268.

The communication unit/module 260 comprises computer program code that, when executed by processing circuitry 250, configures UE 20 to communicate with gNB 40 and LMF 52 via NG-RAN 30, as previously described. To that end, UE 20 sends data to, and receives data from, these entities, as previously described.

The carrier phase measurement update rate determination unit/module 262 comprises computer program code that, when executed by processing circuitry 250, configures UE 20 to determine carrier phase measurement update rate, as previously described.

The carrier phase measurement unit/module 264 comprises computer program code that, when executed by processing circuitry 250, configures UE 20 to perform carrier phase measurement, as previously described.

The carrier phase measurement reporting unit/module 266 comprises computer program code that, when executed by processing circuitry 250, configures UE 20 to report carrier phase measurements, as previously described.

The carrier phase measurement update rate validity unit/module 268 comprises computer program code that, when executed by processing circuitry 250, configures UE 20 to validate the determined carrier phase measurement update rates, as previously described.

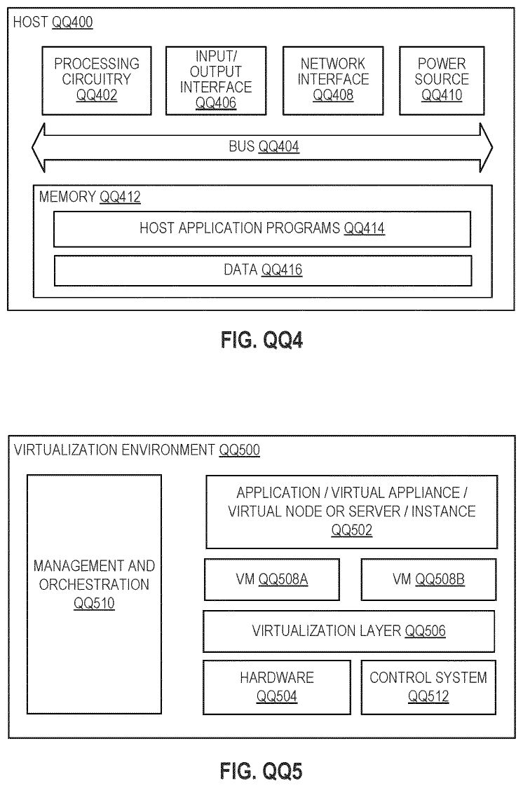

FIG. 17 is a functional block diagram illustrating some components of a network node 270 configured to determine a carrier phase measurement update rate for a UE moving through the network according to one embodiment of the present disclosure. By way of example only, network node 270 may be, as previously stated, a gNB 40 or LMF 52.

As seen in FIG. 17, node 270 comprises processing circuitry 280, memory circuitry 282, and communications circuitry 286. Additionally, as described in more detail below, memory circuitry 282 stores a computer program 284 that, when executed by processing circuitry 280, configures node 270 to implement the methods herein described.

In more detail, processing circuitry 280 controls the overall operation of node 270 and processes the data and information according to the present embodiments. Such processing includes, but is not limited to, determining a carrier phase measurement update rate for a UE 20 moving through a communications network based on a carrier frequency and a current velocity of UE 20, and sending the carrier phase measurement update rate to UE 20 in a carrier phase measurement update rate configuration. Additionally, the processing further includes node 270 receiving a capability of UE 20 for performing carrier phase measurements and/or a current velocity of UE. 20, and in response, sending assistance data for performing the carrier phase measurements along with the carrier phase measurement update rate to UE 20. Further, the processing also includes node 270 receiving carrier phase measurement reports from UE 20 according to the carrier phase measurement update rate. The processing further includes node 270 sending an estimated position to UE 20 in cases where UE 20 is not capable of performing UE-based carrier phase positioning. In some cases, the estimated position of UE 20 may be sent to a requesting third party. In this regard, processing circuitry 280 may comprise one or more microprocessors, hardware, firmware, or a combination thereof.

Memory circuitry 282 comprises both volatile and non-volatile memory for storing computer program code and data needed by the processing circuitry 280 for operation. Memory circuitry 282 may comprise any tangible, non-transitory computer-readable storage medium for storing data including electronic, magnetic, optical, electromagnetic, or semiconductor data storage. As stated above, memory circuitry 282 stores a computer program 284 comprising executable instructions that configure the processing circuitry 280 to implement the methods herein described. A computer program 284 in this regard may comprise one or more code modules corresponding to the functions described above.

In general, computer program instructions, such as computer program 284, and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 284 for configuring the processing circuitry 280 as herein described may be stored in a removable memory, such as a portable compact disc, portable digital video disc, or other removable media. The computer program 284 may also be embodied in a carrier such as an electronic signal, optical signal, radio signal, or computer readable storage medium.

The communications circuitry 286 communicatively connects node 270 to UE 20, as is known in the art. For example, in embodiments where node 270 is a gNB 40, node 270 communicatively connects to UE 270 and to LMF 52 using the appropriate protocols, as previously described. In embodiments where node 270 is a LMF 52, however, communications interface circuitry 286 communicatively connects node 270 to NG-RAM 30, and indirectly connects to UE 20 via gNB 40. As such, communications circuitry 286 may comprise, for example, an ETHERNET card or other circuitry configured to communicate with one or more other nodes via a communications network.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, such as processing circuitry 280. Such processing circuitry may include one or more microprocessor or microcontrollers, as well as other digital hardware, which may include digital signal processors (DSPs), special-purpose digital logic, and the like. The processing circuitry may be configured to execute program code (e.g., computer program 284) stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

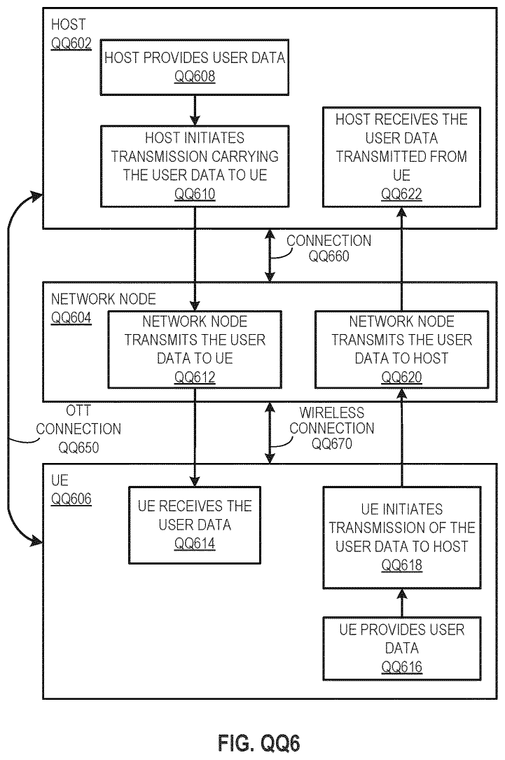

FIG. 18 is a functional block diagram illustrating a computer program 284 that, when executed by the processing circuitry 280 of network node 270, causes network node 270 to perform the methods herein described. Particularly, as seen in FIG. 18, computer program 284 executed by processing circuitry 280 comprises a communication unit/module 290, a carrier phase measurement update rate determination unit/module 292, and a UE location estimation unit/module 294.

The communication unit/module 290 comprises computer program code that, when executed by processing circuitry 280, configures node 270 to communicate with UE 20, and/or gNB 40 and LMF 52, as previously described. To that end, node 270 sends data to, and receives data from, these entities, as previously described.

The carrier phase measurement update rate determination unit/module 292 comprises computer program code that, when executed by processing circuitry 280, configures node 270 to determine a carrier phase measurement update rate, as previously described.

The UE location estimation unit/module 294 comprises computer program code that, when executed by processing circuitry 280, configures node 270 to estimate the location of UE 20 based on the carrier phase measurement reports provided by UE 20, as previously described.

Embodiments further include a carrier containing such as computer program 254 and computer program 284. This carrier may comprise one of an electronic signal, optical signal, radio signal, or computer readable storage medium.

Embodiments herein also include a computer program product stored on a non-transitory computer readable (storage or recording) medium (e.g., memory circuitry 252 and/or memory circuitry 284) and comprising instructions that, when executed by the processing circuitry (e.g., processing circuitry 250 and/or processing circuitry 280) of an apparatus, causes the apparatus to perform as described above.

Embodiments further include a computer program product comprising program code portions for performing the steps of any of the embodiments herein when the computer program product is executed by a computing device, such as UE 20 and/or network node 270, for example. This computer program product may be stored on a computer readable recording medium (e.g., memory circuitry 252 and/or memory circuitry 284).

FIG. QQ1 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

FIG. QQ2 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. QQ3 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. QQ4 is a block diagram of a host QQ400, which may be an embodiment of the host QQ116 of FIG. QQ1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. QQ5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. QQ6 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. QQ1 and/or UE QQ200 of FIG. QQ2), network node (such as network node QQ110a of FIG. QQ1 and/or network node QQ300 of FIG. QQ3), and host (such as host QQ116 of FIG. QQ1 and/or host QQ400 of FIG. QQ4) discussed in the preceding paragraphs will now be described with reference to FIG. QQ6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may provide benefits and advantages that conventional systems do not provide. For example, by removing the effect of the Doppler frequency of a moving UE, the accuracy of the carrier phase measurements, as well as the positioning estimation based on the carrier phase measurements, is greatly improved. Additionally, the present embodiments provide a method for accurately removing the effects of the Doppler frequency, and appropriately samples the Doppler component. This allows for the proper tracking of the Doppler parameter.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present embodiments may, of course, be carried out in other ways than those specifically set forth herein without departing from essential characteristics of the present disclosure. The present embodiments are to be considered in all respects as illustrative and not restrictive, and all changes coming within the meaning and equivalency range of the appended claims are intended to be embraced therein.

Additional information may also be found in the document(s) provided in the Appendix.

### EMBODIMENTS

1. A method (120) for performing carrier phase measurements in a communication network, the method implemented by a User Equipment (UE) (20) moving through the network and comprising:
   determining (124) a carrier phase measurement update rate for the UE based on a carrier frequency and a current velocity of the UE; and
   performing (126) carrier phase measurements according to the carrier phase measurement update rate.
2. A method (140) for performing carrier phase measurements in a communication network, the method implemented by a User Equipment (UE) (20) moving through the network and comprising:
   determining (144) a carrier phase measurement update rate for the UE based on a carrier frequency and a current velocity of the UE;
   performing (146) carrier phase measurements; and
   reporting (148) the carrier phase measurements to the network according to the carrier phase measurement update rate.
3. The method according to any of embodiments 1-2, further comprising:
   sampling (222) the carrier phase measurements at a sampling rate sufficient to ensure at least Nyquist sampling of a Doppler component;
   estimating (224) a Doppler frequency based on the sampling; and
   removing (226) the estimated Doppler frequency from the carrier phase measurements.
4. The method according to any of embodiments 1-3, wherein the Doppler frequency is estimated based on an estimated maximum velocity for the UE.
5. The method according to any of embodiments 1-4, wherein the carrier phase measurement update rate for the UE is determined based on the carrier phase measurements after the Doppler frequency has been removed.
6. The method according to any of embodiments 1-5, further comprising reporting (122, 142), to the network, one or both of a capability for carrier phase measurement by the UE and the current velocity for the UE.
7. The method according to embodiment 6, wherein the current velocity for the UE is based on a measurement of an Inertial Measurement Unit (IMU) sensor at the UE.
8. The method according to embodiment 6 or 7, wherein reporting the current velocity for the UE triggers a request for assistance data from the network for performing the carrier phase measurements.
9. The method according to embodiment 8, wherein the assistance data for performing the carrier phase measurements is received from the network responsive to the UE reporting the current velocity.
10. The method according to any of embodiments 1-9, wherein the carrier phase measurement update rate for the UE is received from the network in a carrier phase measurement update rate configuration.
11. The method according to any of embodiments 1 and 3-10, wherein the UE refrains from reporting the carrier phase measurements to the network according to the carrier phase measurement update rate when the UE is capable of UE-based carrier phase positioning.
12. The method according to any of embodiments 2-10, wherein the UE reports the carrier phase measurements to the network when the UE is not capable of performing UE-based carrier phase positioning.
13. The method according to embodiment 12 further comprising receiving (130, 150) an estimated position of the UE from the network when the UE is not capable of performing UE-based carrier phase positioning, wherein the estimated position of the UE is based on the carrier phase measurements reported to the network.
14. A method (160) for performing carrier phase measurements in a communication network, the method implemented by a network node (270) in a communication network and comprising:
   determining (164) a carrier phase measurement update rate for a User Equipment (UE) (20) moving through the network based on a carrier frequency and a current velocity of the UE; and
   sending (166) the carrier phase measurement update rate to the UE in a carrier phase measurement update rate configuration.
15. The method according to embodiment 14 further comprising receiving (170) carrier phase measurement reports from the UE according to the carrier phase measurement update rate when the UE is not capable of UE-based carrier phase positioning.
16. The method according to any of embodiments 14-15, further comprising:
   sampling (222) the carrier phase measurements at a sampling rate sufficient to ensure at least Nyquist sampling of a Doppler component;
   estimating (224) a Doppler frequency based on the sampling; and
   removing (226) the estimated Doppler frequency from the carrier phase measurements.
17. The method according to any of embodiments 14-16, wherein the Doppler frequency is estimated based on an estimated maximum velocity for the UE.
18. The method according to any of embodiments 14-17, wherein the carrier phase measurement update rate for the UE is determined based on the carrier phase measurements after the Doppler frequency has been removed.
19. The method according to any of embodiments 14-18, further comprising receiving (162), from the UE, one or both of a capability of the UE for performing carrier phase measurements and the current velocity of the UE.
20. The method according to embodiment 19 further comprising sending (168), to the UE and along with the carrier phase measurement update rate, assistance data for performing the carrier phase measurements responsive to receiving the one or both of the capability for carrier phase measurement of the UE and the current velocity of the UE.
21. The method according to embodiment 20, further comprising sending (172), to the UE, an estimated position of the UE when the UE is not capable of performing UE-based carrier phase positioning, wherein the estimated position of the UE is determined based on the carrier phase measurements reported to the network.
22. The method according to embodiment 21, wherein the estimated position of the UE is sent to a third party device responsive to receiving a location request for the UE from the third party.
23. The method according to embodiment 14, wherein the network comprises context information indicating an estimated capability of the UE for performing carrier phase measurements and an estimated velocity for the UE, and wherein the network controls the UE to initiate performing the carrier phase measurements based on the context information.
24. The method according to embodiment 23, wherein the carrier phase measurement update rate is sent to the UE based on the estimated velocity for the UE.
25. The method according to embodiment 24, wherein the estimated velocity for the UE is determined based on a handover rate for the UE.
26. The method according to embodiment 24, wherein the estimated velocity for the UE is determined based on Doppler information obtained from one or more cells connected to the UE.
27. The method according to embodiment 23, wherein the estimated capability of the UE for performing carrier phase measurements and the estimated velocity for the UE are based on information associated with one or more previous UE positioning procedures.
28. The method according to any of embodiments 14-27, wherein a scheduling restriction is determined based on the carrier phase measurement update rate configuration sent to the UE.
29. The method according to any of embodiments 14-27, wherein scheduling of one or more downlink channels is determined based on the carrier phase measurement update rate configuration sent to the UE.
30. A method (180) for performing carrier phase measurements in a communication network, the method implemented by a User Equipment (UE) (20) moving through the network and comprising:
   receiving (184, 186), from the network:
      assistance data for performing carrier phase measurements; and
      a plurality of carrier phase measurement update configurations, wherein each carrier phase measurement update configuration includes a corresponding carrier phase measurement update rate and maps to a different velocity of the UE;
   selecting (188) a carrier phase measurement update rate from the plurality of carrier phase measurement update configurations based on a carrier frequency and a current velocity of the UE; and
   performing (190) carrier phase measurements according to the selected carrier phase measurement update rate.
31. A method (200) for performing carrier phase measurements in a communication network, the method implemented by a User Equipment (UE) (20) moving through the network and comprising:
   receiving (204, 206), from the network:
      assistance data for performing carrier phase measurements; and
      a plurality of carrier phase measurement update configurations, wherein each carrier phase measurement update configuration includes a corresponding carrier phase measurement update rate and maps to a different velocity of the UE;
   selecting (208) a carrier phase measurement update rate from the plurality of carrier phase measurement update configurations based on a carrier frequency and a current velocity of the UE;
   performing (210) the carrier phase measurements; and
   reporting (212) the carrier phase measurements to the network according to the selected carrier phase measurement update rate.
32. The method according to embodiment 30, wherein the selected carrier phase measurement rate specifies a rate or periodicity with which the UE performs the carrier phase measurements.
33. The method according to embodiment 31, wherein the selected carrier phase measurement rate specifies a rate or periodicity with which the UE reports the carrier phase measurements to the network.
34. The method according to any of embodiments 30-31, wherein the selected carrier phase measurement rate specifies:
   a rate or periodicity with which the UE performs the carrier phase measurements to the network; and
   a rate or periodicity with which the UE reports the carrier phase measurements to the network.
35. The method according to any of embodiments 30-34, wherein the UE refrains from reporting, to the network, the capability for performing carrier phase measurements when the network comprises an estimation of the capability of the UE for performing carrier phase measurements.
36. The method according to any of embodiments 30-35, wherein the UE refrains from reporting, to the network, one or more velocities at which the UE is capable of operating when the network comprises an estimation of the one or more velocities at which the UE is capable of operating.
37. The method according to any of embodiments 30-35, wherein the UE refrains from reporting, to the network, one or more velocity ranges at which the UE is capable of operating when the network comprises an estimation of the one or more velocity ranges at which the UE is capable of operating.
38. The method of any of embodiments 30-37, further comprising requesting (202) the assistance data from the network.
39. The method according to any of embodiments 30-35, wherein each carrier phase measurement update configuration includes a corresponding carrier phase measurement update rate and maps to a different velocity range of the UE.
40. The method according to any of embodiments 30-39, wherein the UE selects the carrier phase measurement update rate from the plurality of carrier phase measurement update configurations based on the carrier frequency and a velocity range of the UE.
41. The method according to embodiment 40, wherein the UE selects the carrier phase measurement update rate and reports the carrier phase measurements to the network according to the selected carrier phase measurement update rate when the UE is capable of UE-assisted positioning.
42. The method according to any of embodiments 30-35, further comprising receiving (214), from the network, an estimated location of the UE.
43. The method according to any of the preceding embodiments, wherein the carrier phase measurement update rate is updated to a discontinued reception cycle configured at the UE when the UE is not in a RRC_CONNECTED mode.
44. The method according to any of the preceding embodiments, wherein the carrier phase measurement update rate varies based on changes in the velocity of the UE.
45. The method according to any of the preceding embodiments, wherein a carrier phase measurement report sent to the network comprises one or more measurement instances with each measurement instance being tagged with the carrier phase measurement update rate.
46. The method according to embodiment 45, wherein each measurement instance comprises a plurality of measurements having a same carrier phase measurement update rate.
47. The method according to any of the preceding embodiments, further comprising:
   determining (232) whether the carrier phase measurement update rate is valid based on an estimated current velocity for the UE; and
   dynamically updating (234) the carrier phase measurement update rate based on the determining.
48. The method according to embodiment 47, implemented by the UE.
49. The method according to embodiment 47, implemented by a network node in the network.
50. The method according to any of the preceding embodiments, further comprising the UE requesting (242) the network to send downlink reference signals for carrier phase measurement at a requested rate.
51. The method according to embodiment 50, wherein requesting the network to send downlink reference signals for carrier phase measurement at a requested rate comprises the UE initiating a Downlink (DL) Positioning Reference Signal (PRS) reconfiguration request to a Location Management Function (LMF).
52. The method according to any of the preceding embodiments, further comprising, for UE-based positioning, the UE requesting (244) to be allocated slots for uplink (UL) reference signals at a specific rate.
53. The method according to any of the preceding embodiments, wherein the UE receives a request from the network for the UE to transmit UL reference signals for carrier phase measurements at a specific rate.
54. The method according to any of the preceding embodiments, further comprising the UE, responsive to receiving a request from the network:
   adapting (246) a rate of DL reference signals for carrier phase measurements; and
   requesting (248) the UE to perform and report the carrier phase measurements responsive to an LMF initiating a DL PRS reconfiguration request.
55. A User Equipment (UE) (20) for performing carrier phase measurements in a communication network, the UE configured to:
   determine (124) a carrier phase measurement update rate for the UE based on a carrier frequency and a current velocity of the UE; and
   perform (126) carrier phase measurements according to the carrier phase measurement update rate.
56. The UE according to embodiment 55, further configured to perform the method of any of embodiments 3-11, 43-48, and 50-54.
57. A User Equipment (UE) (20) for performing carrier phase measurements in a communication network, the UE comprising:
   processing circuitry (250); and
   memory circuitry (252) comprising executable instructions stored thereon that, when executed by the processing circuitry, causes the UE to:
      determine (124) a carrier phase measurement update rate for the UE based on a carrier frequency and a current velocity of the UE; and
      perform (126) carrier phase measurements according to the carrier phase measurement update rate.
58. The UE according to embodiment 57, wherein the executable instructions, when executed by the processing circuitry, further causes the UE to perform the method of any of embodiments 3-11, 43-48, and 50-54.
59. A non-transitory computer readable medium (252) comprising program code (254) stored thereon that, when executed by processing circuitry (250) of a User Equipment (UE) (20) in a communications network, causes the UE to:
   determine (124) a carrier phase measurement update rate for the UE based on a carrier frequency and a current velocity of the UE; and
   perform (126) carrier phase measurements according to the carrier phase measurement update rate.
60. The non-transitory computer readable medium of embodiment 59, wherein the program code, when executed by the processing circuitry, further causes the UE to perform the method of any of embodiments 3-11, 43-48, and 50-54.
61. A computer program (254) comprising executable instructions that, when executed by a processing circuitry (250) in a User Equipment (UE) (20), causes the UE to perform any one of the methods of embodiments 1, 3-11, 43-48, and 50-54.
62. A User Equipment (UE) (20) for performing carrier phase measurements in a communication network, the UE configured to:
   determine (144) a carrier phase measurement update rate for the UE based on a carrier frequency and a current velocity of the UE;
   perform (146) carrier phase measurements; and
   report (148) the carrier phase measurements to the network according to the carrier phase measurement update rate.
63. The UE according to embodiment 62, further configured to perform the method of any of embodiments 3-10, 12-13, 43-48, and 50-54.
64. A User Equipment (UE) (20) for performing carrier phase measurements in a communication network, the UE comprising:
   processing circuitry (250); and
   memory circuitry (252) comprising executable instructions stored thereon that, when executed by the processing circuitry, causes the UE to:
      determine (144) a carrier phase measurement update rate for the UE based on a carrier frequency and a current velocity of the UE;
      perform (146) carrier phase measurements; and
      report (148) the carrier phase measurements to the network according to the carrier phase measurement update rate.
65. The UE according to embodiment 64, wherein the executable instructions, when executed by the processing circuitry, further causes the UE to perform the method of any of embodiments 3-10, 12-13, 43-48, and 50-54.
66. A non-transitory computer readable medium (252) comprising program code (254) stored thereon that, when executed by processing circuitry (250) of a User Equipment (UE) (20) in a communications network, causes the UE to:
   determine (144) a carrier phase measurement update rate for the UE based on a carrier frequency and a current velocity of the UE;
   perform (146) carrier phase measurements; and
   report (148) the carrier phase measurements to the network according to the carrier phase measurement update rate.
67. The non-transitory computer readable medium of embodiment 66, wherein the program code, when executed by the processing circuitry, further causes the UE to perform the method of any of embodiments 3-11, 43-48, and 50-54.
68. A computer program (254) comprising executable instructions that, when executed by a processing circuitry in a User Equipment (UE) (20), causes the UE to perform any one of the methods of embodiments 2-3-11, 43-48, and 50-54.
69. A network node (270) for performing carrier phase measurements in a communication network, the network node configured to:
   determine (164) a carrier phase measurement update rate for a User Equipment (UE) (20) moving through the network based on a carrier frequency and a current velocity of the UE; and
   send (166) the carrier phase measurement update rate to the UE in a carrier phase measurement update rate configuration.
70. The network node according to embodiment 69, further configured to perform the method of any of embodiments 15-29, 43-47, and 49.
71. A network node (270) for performing carrier phase measurements in a communication network, the network node comprising:
   processing circuitry; (280) and
   memory circuitry (282) comprising executable instructions stored thereon that, when executed by the processing circuitry, causes the network node to:
      determine (164) a carrier phase measurement update rate for a User Equipment (UE) (20) moving through the network based on a carrier frequency and a current velocity of the UE; and
      send (166) the carrier phase measurement update rate to the UE in a carrier phase measurement update rate configuration.
72. The network node according to embodiment 71, wherein the executable instructions, when executed by the processing circuitry, further causes the network node to perform the method of any of embodiments 15-29, 43-47, and 49.
73. A non-transitory computer readable medium (282) comprising program code (284) stored thereon that, when executed by processing circuitry of a network node (270) in a communications network, causes the network node to:
   determine (164) a carrier phase measurement update rate for a User Equipment (UE) (20) moving through the network based on a carrier frequency and a current velocity of the UE; and
   send (166) the carrier phase measurement update rate to the UE in a carrier phase measurement update rate configuration.
74. The non-transitory computer readable medium of embodiment 73, wherein the program code, when executed by the processing circuitry, further causes the network node to perform the method of any of embodiments 15-29, 43-47, and 49.
75. A computer program (284) comprising executable instructions that, when executed by a processing circuitry in a network node (270), causes the network node to perform any one of the methods of embodiments 15-29, 43-47, and 49.
76. A User Equipment (UE) (20) for performing carrier phase measurements in a communication network, the UE configured to:
   receive (184, 186), from the network:
      assistance data for performing carrier phase measurements; and
      a plurality of carrier phase measurement update configurations, wherein each carrier phase measurement update configuration includes a corresponding carrier phase measurement update rate and maps to a different velocity of the UE;
   select (188) a carrier phase measurement update rate from the plurality of carrier phase measurement update configurations based on a carrier frequency and a current velocity of the UE; and
   perform (190) carrier phase measurements according to the selected carrier phase measurement update rate.
77. The UE according to embodiment 76, further configured to perform the method of any of embodiments 32, 34-48, and 50-54.
78. A User Equipment (UE) (20) for performing carrier phase measurements in a communication network, the UE comprising:
   processing circuitry (250); and
   memory circuitry (252) comprising executable instructions stored thereon that, when executed by the processing circuitry, causes the UE to:
      receive (184, 186), from the network:
         assistance data for performing carrier phase measurements; and
         a plurality of carrier phase measurement update configurations, wherein each carrier phase measurement update configuration includes a corresponding carrier phase measurement update rate and maps to a different velocity of the UE;
      select (188) a carrier phase measurement update rate from the plurality of carrier phase measurement update configurations based on a carrier frequency and a current velocity of the UE; and
      perform (190) carrier phase measurements according to the selected carrier phase measurement update rate.
79. The UE according to embodiment 78, wherein the executable instructions, when executed by the processing circuitry, further causes the UE to perform the method of any of embodiments 32, 34-48, and 50-54.
80. A non-transitory computer readable medium (252) comprising program code (254) stored thereon that, when executed by processing circuitry (250) of a User Equipment (UE) (20) in a communications network, causes the UE to:
   receive (184, 186), from the network:
      assistance data for performing carrier phase measurements; and
      a plurality of carrier phase measurement update configurations, wherein each carrier phase measurement update configuration includes a corresponding carrier phase measurement update rate and maps to a different velocity of the UE;
   select (188) a carrier phase measurement update rate from the plurality of carrier phase measurement update configurations based on a carrier frequency and a current velocity of the UE; and
   perform (190) carrier phase measurements according to the selected carrier phase measurement update rate.
81. The non-transitory computer readable medium of embodiment 80, wherein the program code, when executed by the processing circuitry, further causes the UE to perform the method of any of embodiments 32, 34-48, and 50-54.
82. A computer program (254) comprising executable instructions that, when executed by a processing circuitry (250) in a User Equipment (UE) (20), causes the UE to perform any one of the methods of embodiments 30, 32, 34-48, and 50-54.
83. A User Equipment (UE) (20) for performing carrier phase measurements in a communication network, the UE configured to:
   receive (204, 206), from the network:
      assistance data for performing carrier phase measurements; and
      a plurality of carrier phase measurement update configurations, wherein each carrier phase measurement update configuration includes a corresponding carrier phase measurement update rate and maps to a different velocity of the UE;
   select (208) a carrier phase measurement update rate from the plurality of carrier phase measurement update configurations based on a carrier frequency and a current velocity of the UE;
   perform (210) the carrier phase measurements; and
   report (212) the carrier phase measurements to the network according to the selected carrier phase measurement update rate.
84. The UE according to embodiment 83, further configured to perform the method of any of embodiments 33-48 and 50-54.
85. A User Equipment (UE) (20) for performing carrier phase measurements in a communication network, the UE comprising:
   processing circuitry (250); and
   memory circuitry (252) comprising executable instructions stored thereon that, when executed by the processing circuitry, causes the UE to:
      receive (204, 206), from the network:
         assistance data for performing carrier phase measurements; and
         a plurality of carrier phase measurement update configurations, wherein each carrier phase measurement update configuration includes a corresponding carrier phase measurement update rate and maps to a different velocity of the UE;
      select (208) a carrier phase measurement update rate from the plurality of carrier phase measurement update configurations based on a carrier frequency and a current velocity of the UE;
      perform (210) the carrier phase measurements; and
      report (212) the carrier phase measurements to the network according to the selected carrier phase measurement update rate.
86. The UE according to embodiment 85, wherein the executable instructions, when executed by the processing circuitry, further causes the UE to perform the method of any of embodiments 33-48 and 50-54.
87. A non-transitory computer readable medium (254) comprising program code stored thereon that, when executed by processing circuitry (250) of a User Equipment (UE) (20) in a communications network, causes the UE to:
   receive (204, 206), from the network:
      assistance data for performing carrier phase measurements; and
      a plurality of carrier phase measurement update configurations, wherein each carrier phase measurement update configuration includes a corresponding carrier phase measurement update rate and maps to a different velocity of the UE;
   select (208) a carrier phase measurement update rate from the plurality of carrier phase measurement update configurations based on a carrier frequency and a current velocity of the UE;
   perform (210) the carrier phase measurements; and
   report (212) the carrier phase measurements to the network according to the selected carrier phase measurement update rate.
88. The non-transitory computer readable medium of embodiment 59, wherein the program code, when executed by the processing circuitry, further causes the UE to perform the method of any of embodiments 33-48 and 50-54.
89. A computer program (254) comprising executable instructions that, when executed by a processing circuitry (250) in a User Equipment (UE) (20), causes the UE to perform any one of the methods of embodiments 33-48 and 50-54.
90. A carrier containing the computer program of any of embodiments 61, 68, 75, 82, and 88, wherein the carrier is one of an electronic signal, optical signal, radio signal, or computer readable storage medium.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1x RTT CDMA2000 1x Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1-17. (canceled)

18. A method, in a network node, for carrier phase measurements in a communication network, the method comprising:
obtaining a carrier phase measurement update rate for a User Equipment (UE) moving through the network based on a carrier frequency and a velocity of the UE; and
sending the carrier phase measurement update rate to the UE in a carrier phase measurement update rate configuration.

19. The method according to claim 18, further comprising:
receiving carrier phase measurement reports from the UE;
sampling the received carrier phase measurements at a sampling rate sufficient to ensure at least Nyquist sampling of a Doppler component;
estimating a Doppler frequency based on the sampling;
removing the estimated Doppler frequency from the carrier phase measurements; and
wherein obtaining the carrier phase measurement update rate for the UE comprises determining, by the network node, the carrier phase measurement update rate for the UE based on the carrier phase measurements after the Doppler frequency has been removed.

20. The method according to claim 18, further comprising estimating the velocity of the UE based on at least one of:
a handover rate for the UE;
Doppler information obtained from one or more cells connected to the UE; and
information associated with one or more previous UE positioning procedures.

21. The method according to claim 18, further comprising sending a plurality of carrier phase measurement update configurations to the UE, wherein each carrier phase measurement update configuration includes a corresponding carrier phase measurement update rate and maps to a different velocity of the UE.

22. The method according to claim 18, wherein the carrier phase measurement update rate configuration comprises an update rate of downlink reference signals for carrier phase measurements, the method further comprising:
receiving a downlink reference signal reconfiguration request from a Location Management Function (LMF); and
wherein the downlink reference signal is Downlink Positioning Reference Signal (DL PRS).

23. The method according to claim 18, wherein the carrier phase measurement update rate configuration comprises a request for uplink reference signals for carrier phase measurements at a specific rate and resources for the uplink reference signals.

24. The method according to claim 19, further comprising:
receiving, from the UE, the current velocity of the UE;
sending assistance data for performing the carrier phase measurements to the UE; and
sending an estimated position of the UE to the UE and/or a third-party device.

25. A method, in a user equipment (UE) moving through a communication network, for carrier phase measurements in the network, the method comprising:
obtaining, a carrier phase measurement update rate for the UE; and
performing carrier phase measurements based on obtained the carrier phase measurement update rate.

26. The method according to claim 25, further comprising:
sampling previous carrier phase measurements at a sampling rate sufficient to ensure at least Nyquist sampling of a Doppler component;
estimating a Doppler frequency based on the sampling;
removing the estimated Doppler frequency from the previous carrier phase measurements; and
wherein the obtaining a carrier phase measurement update rate comprises determining, by the UE, the carrier phase measurement update rate based on the previous carrier phase measurements after the Doppler frequency has been removed.

27. The method according to claim 25, wherein obtaining the carrier phase measurement update rate comprises receiving a carrier phase measurement update rate configuration comprising the carrier phase measurement update rate.

28. The method according to claim 25, wherein obtaining the carrier phase measurement update rate comprises:
receiving a plurality of carrier phase measurement update configurations, wherein each carrier phase measurement update configuration includes a corresponding carrier phase measurement update rate and maps to a different velocity of the UE; and
selecting a carrier phase measurement update rate from the plurality of carrier phase measurement update configurations based on a carrier frequency and a current velocity of the UE.

29. The method according to claim 25, further comprising requesting an update rate of downlink reference signals for carrier phase measurements.

30. The method according to claim 25, further comprising requesting resource allocation of uplink reference signals at a specific rate.

31. A User Equipment (UE) for performing carrier phase measurements in a communication network, the UE comprising:
processing circuitry; and
memory circuitry comprising executable instructions stored thereon that, when executed by the processing circuitry, causes the UE to:
obtain a carrier phase measurement update rate for the UE; and
perform carrier phase measurements based on the obtained carrier phase measurement update rate.

32. The UE according to claim 31, wherein the executable instructions, when executed by the processing circuitry, further causes the UE to:
sample previous carrier phase measurements at a sampling rate sufficient to ensure at least Nyquist sampling of a Doppler component;
estimate a Doppler frequency based on the sampling;
remove the estimated Doppler frequency from the previous carrier phase measurements; and
wherein to obtain the carrier phase measurement update rate, the executable instructions, when executed by the processing circuitry, further causes the UE to determine the carrier phase measurement update rate based on the previous carrier phase measurements after the Doppler frequency has been removed.

33. The UE according to claim 31, wherein to obtain the carrier phase measurement update rate, the executable instructions, when executed by the processing circuitry, further causes the UE to receive a carrier phase measurement update rate configuration comprising the carrier phase measurement update rate.

34. The UE according to claim 31, wherein to obtain the carrier phase measurement update rate, the executable instructions, when executed by the processing circuitry, further causes the UE to:
receive a plurality of carrier phase measurement update configurations, wherein each carrier phase measurement update configuration includes a corresponding carrier phase measurement update rate and maps to a different velocity of the UE; and
select a carrier phase measurement update rate from the plurality of carrier phase measurement update configurations based on a carrier frequency and a current velocity of the UE.

35. The UE according to claim 31, wherein to obtain the carrier phase measurement update rate, the executable instructions, when executed by the processing circuitry, further causes the UE to request an update rate of downlink reference signals for carrier phase measurements.

36. The method according to claim 31, wherein to obtain the carrier phase measurement update rate, the executable instructions, when executed by the processing circuitry, further causes the UE to request resource allocation of uplink reference signals at a specific rate.
